(19) United States
(12) Patent Application Publication
(10) Pub. No.: US 2012/0085295 A1
(43) Pub. Date: Apr. 12, 2012

(54) Word shaped pet toy

(76) Inventors: Mick Laska, San Anselmo, CA (US); Staysea L. Colteaux, Fairfax, CA (US)

(21) Appl. No.: 12/924,828

(22) Filed: Oct. 6, 2010

(51) Int. Cl. A01K 29/00

(52) U.S. Cl. 119/709

(57) ABSTRACT

Word shaped pet toy with an elongate molded rubber-like structure that is shaped to form three dimensional letters that combine to form a word, and the word forming a plurality of chewable indentations and surfaces resulting from the shapes of the letters. In one embodiment, the elongate structure is molded of solid rubber. In another embodiment, the elongate structure is molded of rubber or rubber-like material and has a hollow interior portion. In another embodiment, the word shaped pet toy includes a standard squeaker mechanism or a standard audio sound emitting electronic circuit.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pet toys and more specifically to a word shaped pet toy.

Pet toys are a well known category of consumer product. One type of popular pet toy is a chew type toy used by dogs to satisfy their desire to gnaw and chew without destroying valuable items such as furniture legs, shoes or other chewable items found around the house. A chew type toy is usually formed into a generic shape such as a bone shape or a ball shape. Some chew toys are made of molded rubber which is a material that can withstand the hard biting activity of a dog.

However, there is a deficiency in the prior technology in that none of the prior designs includes the novel feature of having the toy molded in the shape of a word that is relevant to that of the pet using the toy.

### BRIEF SUMMARY OF THE INVENTION

The primary object of the invention is to provide a novel pet chew toy that is molded in the shape of a word.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed word shaped pet toy comprising: an elongate molded rubber-like structure that is shaped to form three dimensional letters that combine and attach to each other to form a word, and said word forming a plurality of indentations and surfaces resulting from the shapes of said letters that are suitable for chewing on.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an end view of the invention.

FIG. 3 is a bottom view of the invention.

FIG. 4 is a top view of the invention.

FIG. 5 is rear view of the invention.

FIG. 6 is a perspective view of the invention with a squeak mechanism installed.

FIG. 7 is a perspective view of the invention with an audio device installed.

FIG. 8 is a front view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

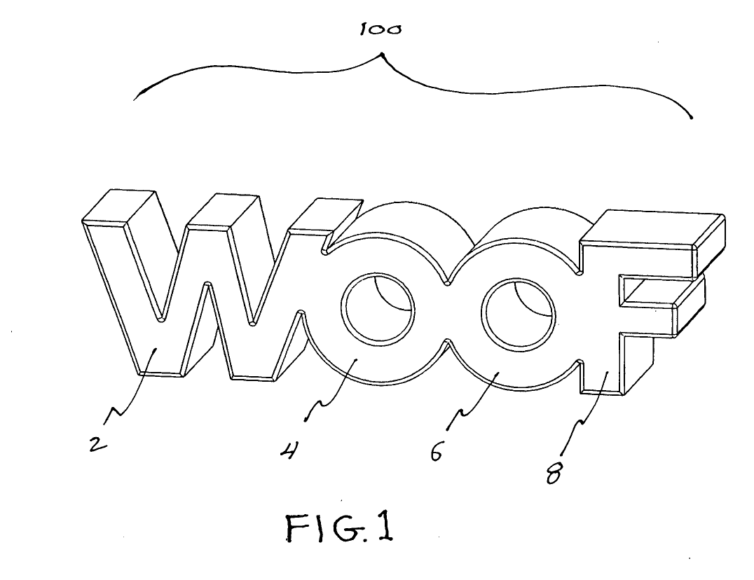

Referring now to FIG. 1 we see a perspective view of the novel word shaped pet toy 100. The toy is an elongate shape that is formed by connected letters 2, 4, 6, 8 to form the word “WOOF”. The word “WOOF” is relevant to the intended user of the toy which is a dog. Dog's tend to make a woof sound when they bark. Therefore the word “WOOF” is relevant and amusing to the pet owner who is playing with a dog and the present invention 100. The toy 100 is molded either of solid rubber or, alternately, can be molded as a hollow structure where the outer surface is in the shape of the word “WOOF” as shown, but the inside of the letters 2, 4, 6, 8 are hollow. The hollow molded version can be made of rubber or a rubber-like thermo plastic elastomer material such as Versaflex OM 6160-9 made by GLS corporation. The indentations and undulations of the letters 2, 4, 6, 8 provide excellent chewing surfaces for a pet dog to gnaw on. Other relevant words may be used for the toy such as the words “BITE ME” or “BARK” or “CHEW TOY” or even words that only loosly relate to a dog such as “DOGMA” or “SEXY”.

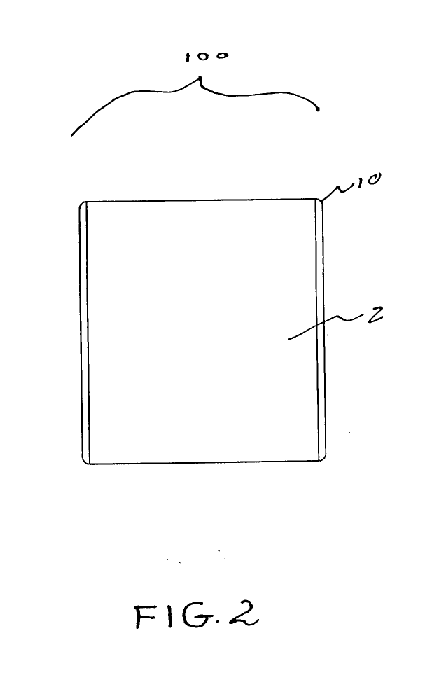

FIG. 2 is an end view of the toy 100. The chamfers 10 on each letter 2, 4, 6, 8 allow easier molding and are easier for a pet dog to chew on.

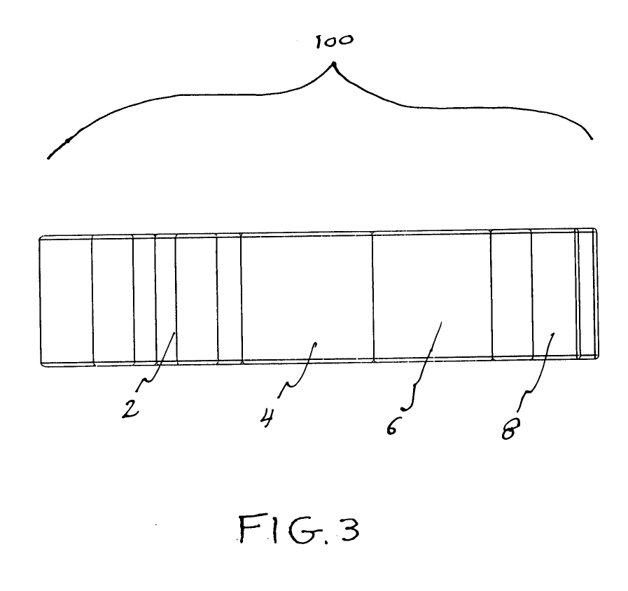

FIG. 3 is a bottom view of the toy 100.

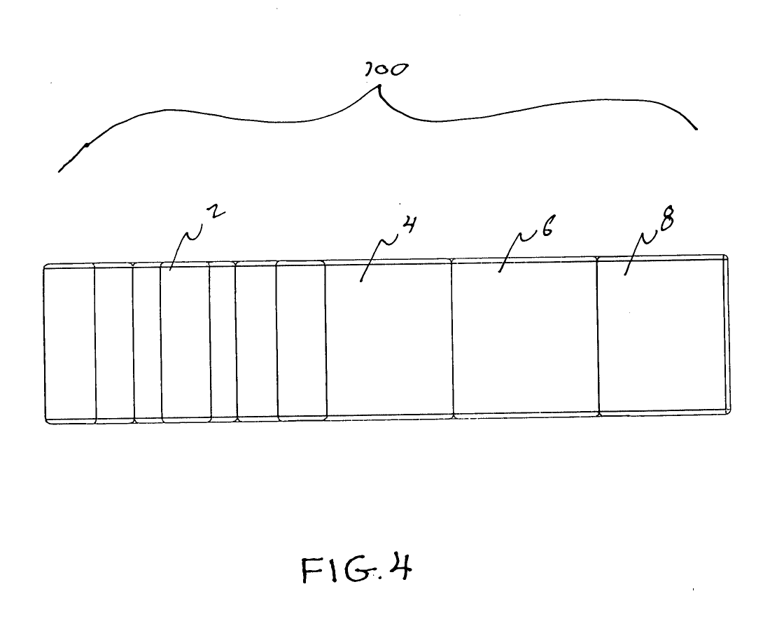

FIG. 4 is a top view of the toy 100.

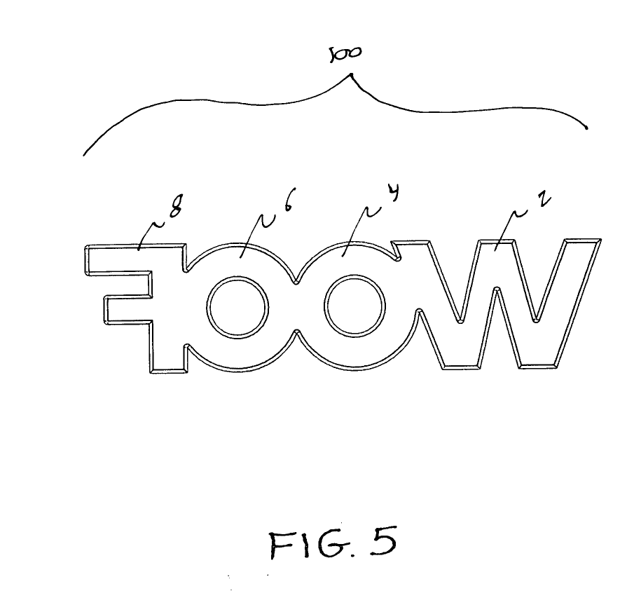

FIG. 5 is a rear view of the toy 100.

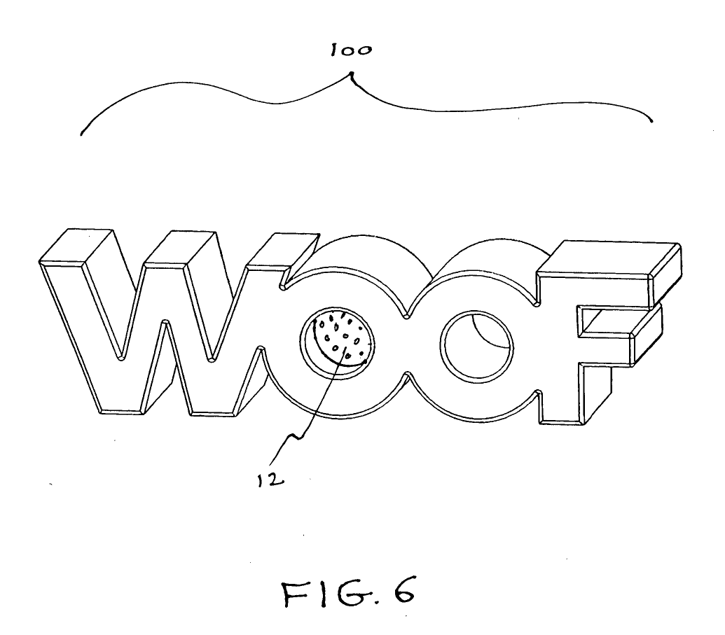

FIG. 6 is an alternate embodiment of the toy 200 where a standard squeaker mechanism 12 has been molded into one of the “O” letters in the pet toy so that when a dog bites on the toy, a squeak sound emanates from the invention 100.

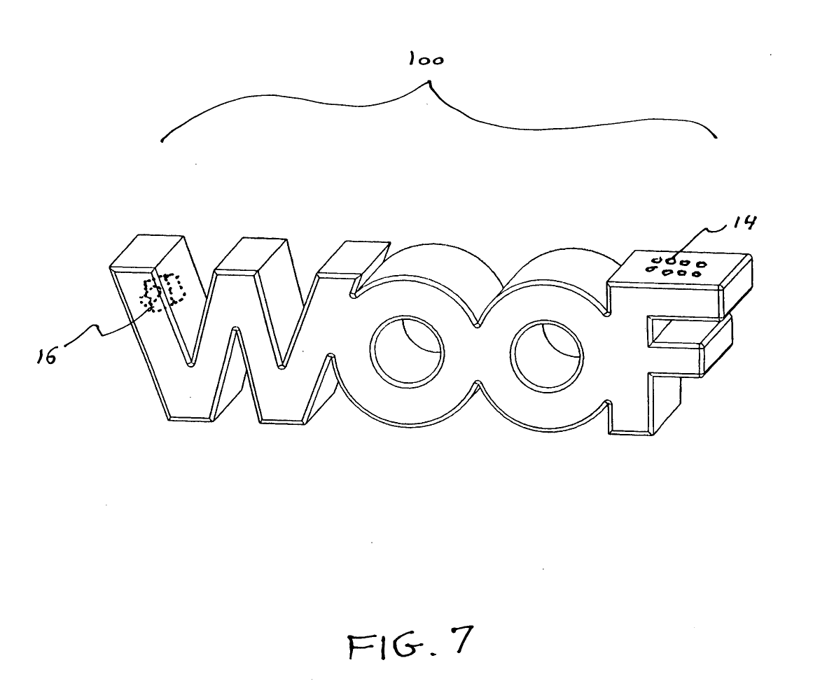

FIG. 7 is a second alternate embodiment of the toy 300 where a standard audio circuit, not shown, has been inserted into the hollow body of the toy. Sound emanates from the speaker apertures 14 when a dog bites on the toy. A standard momentary switch within the toy shown by dotted line 16 is pressed when a dog bites on the toy, thereby activating the audio circuit which can cause the word “woof”, or other relevant words or sounds to be audibly broadcast from the toy.

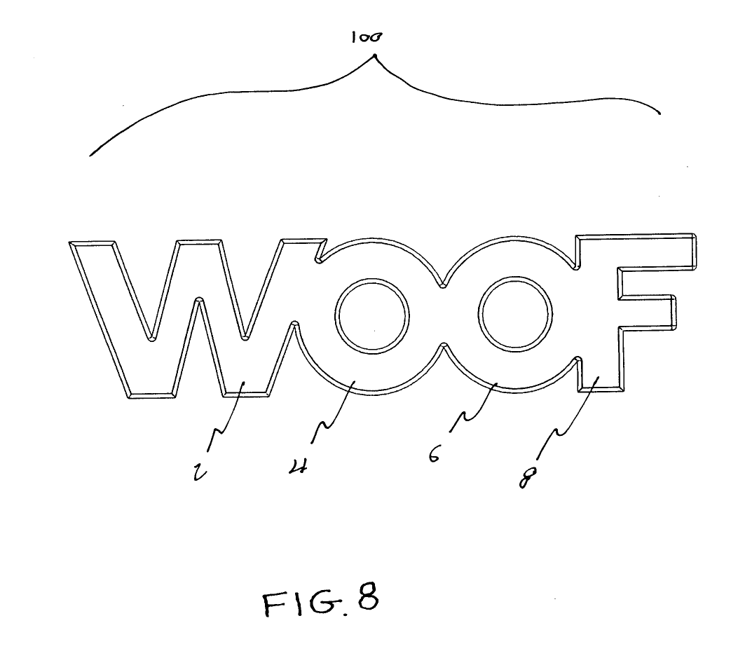

FIG. 8 is a front view of the toy 100.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. word shaped pet toy comprising:
an elongate molded rubber-like structure that is shaped to form attached three dimensional letters that combine to form a word; and
said word forming a plurality of chewable indentations and surfaces resulting from the shapes of said letters.

2. Word shaped pet toy as claimed in claim 1 wherein, in one embodiment, said elongate structure is molded of solid rubber.

3. Word shaped pet toy as claimed in claim 1 wherein, in a second embodiment, said elongate structure is molded in a hollow format where said letters are each comprised of exterior walls and a hollow interior.

4. Word shaped pet toy as claimed in claim 1 wherein said elongate structure is shaped to form the word “WOOF”

5. Word shaped pet toy as claimed in claim 1 wherein said elongate structure is shaped to form the words “BITE ME”

6. Word shaped pet toy as claimed in claim 1 wherein said hollow elongate structure includes the addition of a standard squeak mechanism.

7. Word shaped pet toy as claimed in claim 1 wherein said hollow elongate structure houses within it a standard audio circuit including a speaker and activation switch that causes said pet toy to emit an audible sound when bitten;
said sound corresponding to the said word formed by said word shaped pet toy.
